(19) United States
(12) Patent Application Publication
(10) Pub. No.: US 2018/0157130 A1
(43) Pub. Date: Jun. 7, 2018

(54) LIQUID CRYSTAL DISPLAY DEVICE

(71) Applicant: SHARP KABUSHIKI KAISHA, Sakai City, Osaka (JP)

(72) Inventor: MAYUKO SAKAMOTO, Sakai City (JP)

(21) Appl. No.: 15/576,461

(22) PCT Filed: May 18, 2016
(86) PCT No.: PCT/JP2016/064764

§ 371 Date: Nov. 22, 2017

(30) Foreign Application Priority Data
May 22, 2015 (JP) 2015-104853

(51) Int. Cl. G02F 1/1343; G02F 1/1335; G02F 1/1339; G02F 1/1337; G02F 1/1333

(52) U.S. Cl. CPC G02F 1/134309; G02F 1/13439; G02F 1/133553; G02F 2203/02; G02F 1/1337; G02F 1/133345; G02F 2001/13398; G02F 1/13394

(57) ABSTRACT

Provided is a liquid crystal display device performing reflection display, wherein light leakage in areas where structural members are provided in a liquid crystal layer, and flicker during low frequency driving, are suppressed. The liquid crystal display device includes: a first substrate 11; a reflection electrode 14 provided on the first substrate 11, for each pixel; a second substrate 20 provided so as to be opposed to the first substrate 11; a liquid crystal layer 16 provided between the first substrate 11 and the second substrate 20; and a structural member 17 provided in the liquid crystal layer 16 in such a manner that the structural member 17 protrudes from one of the first substrate 11 and the second substrate 20 toward the other substrate. In an area of each pixel, no reflection electrode 14 is provided in an area where the structural member 17 is provided.

### TECHNICAL FIELD

The present invention relates to a liquid crystal display device.

### BACKGROUND ART

A liquid crystal display device is known that includes a reflection plate and displays an image by reflecting external light with the reflection plate (see JP-A-2008-217017).

### SUMMARY OF THE INVENTION

### Problem to be Solved by the Invention

Commonly, spacers for maintaining a cell thickness (a distance between a pair of substrates between which a liquid crystal layer is interposed) are provided in a liquid crystal display device. Examples of the spacers include spherical particle spacers that are sprayed over pixel portions so as to be arranged, fiber-like spacers used in a state of being mixed in a sealing material, and columnar spacers formed by photolithography. Recently, the columnar spacers (hereinafter referred to as photospacers) are the mainstream spacers, since the positions where they are arranged can be controlled easily. To form the photospacers, for example, an acryl-based resin or the like is used.

Since a material different from a liquid crystal layer is used for structural members such as the photospacers, the retardation of the same is different from that of bulk portions of the liquid crystal layer. In a case where the device is controlled to display black color, therefore, such a phenomenon occurs that light leaks and contrast decreases at portions where structural members such as the photospacers are provided, or that flicker occurs during low frequency driving, etc.

It is an object of the present invention to provide a technique that enables, in a liquid crystal display device that is capable of performing reflection display, to suppress light leakage in an area where structural members are provided in a liquid crystal layer, and occurrence of flicker during low frequency driving.

### Means to Solve the Problem

A liquid crystal display device according to one embodiment of the present invention is a liquid crystal display device capable of performing reflection display by reflecting external light, and the liquid crystal display device includes: a first substrate; a reflection electrode provided on the first substrate, for each pixel; a second substrate provided so as to be opposed to the first substrate; a liquid crystal layer provided between the first substrate and the second substrate; and a structural member provided in the liquid crystal layer in such a manner that the structural member protrudes from one of the first substrate and the second substrate toward the other substrate, wherein, in an area of each pixel, no reflection electrode is provided in an area where the structural member is provided.

### Effect of the Invention

According to the present invention, no reflection electrode is provided in areas where structural members are provided in a liquid crystal layer. Therefore, in the area where the structural members are provided, light leakage when the device is controlled to display black color, and the occurrence of flicker during low frequency driving, can be suppressed.

### BRIEF DESCRIPTION OF DRAWINGS

FIG. 1 is a cross-sectional view of a part of a liquid crystal display device in Embodiment 1, the part being a part where a photospacer is provided.

FIG. 2 is a cross-sectional view of a liquid crystal display device of a comparative example in which a black matrix is formed in an area where a photospacer is provided.

FIG. 3 is a plan view for comparing a margin width in a case where a transparent electrode is formed, and a margin width in a case where a black matrix is formed.

FIG. 4 is a cross-sectional view of a part of a liquid crystal display device in Embodiment 2, the part being a part where an alignment regulation structural member is provided.

FIG. 5 is a plan view illustrating three pixels each of which is divided into two areas in the liquid crystal display device in Embodiment 2.

FIG. 6 is a cross-sectional view taken along line VI-VI in FIG. 5.

FIG. 7 is a cross-sectional view of a part of a liquid crystal display device in Embodiment 3, the part being a part where a photospacer is provided.

FIG. 8 illustrates an exemplary photospacer arrangement in which photospacers are provided at four corners of one display pixel that is composed of three adjacent pixels.

FIG. 9 illustrates an exemplary photospacer arrangement in which two photospacers are provided over two adjacent pixels.

FIG. 10 illustrates an exemplar photospacer arrangement in which nine pixels are assumed to be one unit, and photospacers 17 are provided at four corners of this one unit.

FIG. 11 is a diagram for comparing the reflection aperture ratios, the reflection contrast ratios, the and transmission aperture ratios of configurations where photospacers are provided so as to extend over adjacent pixels, the configurations being the following three configurations: “Without countermeasures (Comparative Example 1)”; “Using BM (Comparative Example 2)”; and, Embodiment 3 (FIG. 9).

FIG. 12 is a cross-sectional view of a part of a liquid crystal display device having such a configuration that no transparent electrode nor a transparent film is provided, the part being a part where a photospacer is provided.

### MODE FOR CARRYING OUT THE INVENTION

A liquid crystal display device according to one embodiment of the present invention is a liquid crystal display device capable of performing reflection display by reflecting external light, and the liquid crystal display device includes: a first substrate; a reflection electrode provided on the first substrate, for each pixel; a second substrate provided so as to be opposed to the first substrate; a liquid crystal layer provided between the first substrate and the second substrate; and a structural member provided in the liquid crystal layer in such a manner that the structural member protrudes from one of the first substrate and the second substrate toward the other substrate, wherein, in an area of each pixel, no reflection electrode is provided in an area where the structural member is provided (the first configuration).

According to the first configuration, in the area where the structural member is provided, light is not reflected. In a case where the display device is controlled to display black color during reflection display, therefore, the light leakage in the areas where the structural members are provided, and the occurrence of flicker during low frequency driving, can be prevented.

The first configuration may further include a light source provided on a side opposite to a side on which the second substrate is provided, with respect to the first substrate, and a transparent electrode provided in an area where the structural member is provided, in the area of each pixel (the second configuration).

According to the second configuration, the areas where the structural members are provided, which do not contribute to reflection properties effectively from the first, can be made transmission display areas where light from the light source is used. This cause the transmission display area to increase, thereby improving the display quality during transmission display.

The first or second configuration can be further characterized in that the structural member includes at least one of a spacer having a length approximately equal to a thickness of the liquid crystal layer, a spacer having a length smaller than the thickness of the liquid crystal layer, and an alignment regulation structural member for regulating alignment of liquid crystal molecules of the liquid crystal layer (the third configuration).

With the third configuration, in a case where the liquid crystal display device that includes a spacer having a length approximately equal to a thickness of the liquid crystal layer, a spacer having a length smaller than the thickness of the liquid crystal layer, or an alignment regulation structural member for regulating alignment of liquid crystal molecules of the liquid crystal layer, is controlled to display black color, the light leakage in the areas where the structural members are provided, or the occurrence of flicker during low frequency driving, can be prevented.

The third configuration may further include an interlayer insulating film that has a through hole and is provided between the first substrate and the liquid crystal layer, and may be further characterized in that the structural member includes the alignment regulation structural member, and the through hole is formed at a position at which the alignment regulation structural member is provided (the fourth configuration).

In a case where the alignment regulation structural members and the through holes are formed at different positions in plan view, the configuration may be such that no reflection electrode is provided in areas where the alignment regulation structural members are provided, and areas where the through holes are provided, which do not contribute to reflection display effectively. But in this configuration, the reflection areas where the reflection electrodes are formed decrease, whereby the display quality during reflection display degrades. According to the fourth configuration, however, the alignment regulation structural members and the through holes are formed at the same positions. The reflection areas are therefore larger as compared with the case where they are formed at different positions, whereby higher display quality during reflection display is achieved.

The third or fourth configuration may be further characterized in that the structural member includes at least one of the spacer having a length approximately equal to the thickness of the liquid crystal layer, and the spacer having a length smaller than the thickness of the liquid crystal layer, and the at least one of the spacer having a length approximately equal to the thickness of the liquid crystal layer and the spacer having a length smaller than the thickness of the liquid crystal layer is provided within the area of the pixel (the fifth configuration).

According to the fifth configuration, in a case of a transflective liquid crystal display device in which transparent electrodes are provided in areas where spacers are provided, the transmission area in the area of each pixel can be increased, whereby the display quality during transmission display can be improved.

The third or fourth configuration may be further characterized in that the structural member includes at least one of the spacer having a length approximately equal to the thickness of the liquid crystal layer, and the spacer having a length smaller than the thickness of the liquid crystal layer, and the at least one of the spacer having a length approximately equal to the thickness of the liquid crystal layer and the spacer having a length smaller than the thickness of the liquid crystal layer is provided so as to extend over adjacent pixels (the sixth configuration).

According to the sixth configuration, the area where no reflection electrode is provided is an area the center of which coincides with midpoint between adjacent pixels. As compared with the configuration in which a spacer is provided in the pixel, therefore, the reflection area can be increased, whereby the display quality during reflection display can be improved.

Any one of the first to sixth configurations may be further characterized in that no reflection electrode is provided, not only in the area where the structural member is provided, but also in a margin area having a predetermined width around the area where the structural member is provided (the seventh configuration).

With the seventh configuration, the light leakage during black display and the occurrence of flicker during low frequency driving can be prevented, in areas of interface between the structural members and the liquid crystal layer, too.

### Embodiment

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

### Embodiment 1

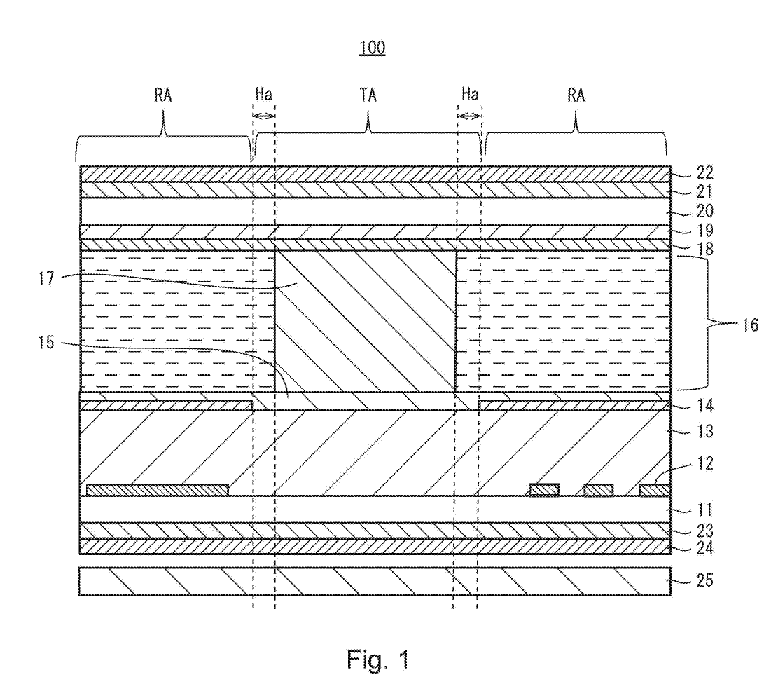

FIG. 1 is a cross-sectional view of a part of a liquid crystal display device 100 in Embodiment 1, the part being a part where a photospacer 17 is provided.

The liquid crystal display device 100 in Embodiment 1 is a transflective liquid crystal display device that is capable of performing reflection display by reflecting external light, and displaying an image of light that is emitted from a backlight as a light source and transmits a liquid crystal layer.

A first substrate (TFT substrate) 11 is, for example, a glass substrate, being transparent and having insulating properties.

On the first substrate 11, a reflection electrode 14 is provided, with an interlayer insulating film 13 being interposed therebetween. The reflection electrode 14 is, for example, a metal film made of aluminum (Al), silver (Ag), or the like, having conductivity and reflecting external light. Each pixel is provided with the reflection electrode 14.

The interlayer insulating film 13 has a function of insulating signal lines 12 and the reflection electrodes 14 provided on the first substrate 11 from each other. The signal lines 12 include lines for supplying signals to the reflection electrodes 14, and the signal lines 12 and the reflection electrodes 14 are electrically connected via through holes that are not illustrated.

A liquid crystal layer 16 is interposed between the first substrate 11, and a second substrate (color filter substrate) 20 provided so as to be opposed to the first substrate 11. The liquid crystal may be of any type, and may have any structure.

The second substrate 20 is, for example, a glass substrate, being transparent and having insulating properties.

On a surface of the second substrate 20 on a side where the liquid crystal layer 16 is provided, color filters 19 are provided. Each color filter 19 has any color of, for example, red (R), green (G), and blue (B). One display pixel is composed of three adjacent pixels corresponding to the color filters 19 of red (R), green (G), and blue (B), respectively, with which display of various colors is enabled.

Between the color filters 19 and the liquid crystal layer 16, a counter electrode 18 is provided. The counter electrode 18 is a transparent electrode that transmits light, which is formed by using a material such as indium tin oxide (ITO) or indium zinc oxide (IZO).

On both outer sides of the liquid crystal layer 16, alignment films are provided, though the illustration of the same is omitted.

On a surface of the second substrate 20 on a side opposite to the side where the color filters 19 are provided, a retarder plate 21 and a polarizing plate 22 are formed in the stated order. Further, on a surface of the first substrate 11 on a side opposite to the side where the signal lines 12 are provided, a retarder plate 23 and a polarizing plate 24 are formed in the stated order.

On a side opposite to the side where the second substrate 20, with respect to the first substrate 11, is provided, a backlight 25 as a light source is provided.

Regarding this liquid crystal display device 100, the surface thereof on the side where the polarizing plate 22 is provided is a front surface that functions as an image display surface, and the surface thereof on the side where the backlight 25 is provided is a rear surface.

In the liquid crystal layer 16, photospacers 17 for maintaining the cell thickness are provided. The photospacers 17 are formed on, for example, the first substrate 13, each of the same having a columnar shape protruding to the second substrate 20 side, having such a length that it reaches the second substrate 20 side (a length approximately equal to the thickness of the liquid crystal layer 16). The photospacers 17, however, may be formed on the second substrate 20. In the present embodiment, the photospacers 17 are provided within the pixels. The photospacers 17 may be provided in every pixel, or alternatively, every predetermined number of pixels.

As described above, in a conventional liquid crystal display device, when it is controlled to display black color, such a phenomenon occurs that light leaks and contrast decreases, or that flicker occurs during low frequency driving, etc., at portions where the photospacers are provided.

In the liquid crystal display device 100 in the present embodiment, therefore, no reflection electrode 14 is provided, but transparent electrodes 15 are provided instead, in areas where the photospacers 17 are provided. The transparent electrodes 15 are electrodes that transmit light, formed with a material such as ITO or IZO. In the present embodiment, not only in the areas where the photospacers 17 are provided, but also in margin areas having a margin width Ha around the foregoing areas, the transparent electrodes 15 are provided in place of the reflection electrodes 14. The transparent electrodes 15 are in contact with the reflection electrodes 14, and have the same potential.

In this case, as illustrated in FIG. 1, the area where the reflection electrode 14 is provided is a reflection area RA at which external light incident from the front side is reflected, and the area where the transparent electrode 15 is provided in place of the reflection electrode 14 is a transmission area TA through which external light incident from the front side is transmitted. This transmission area TA is also an area that is used for performing image display by using light of the backlight 25.

The transparent electrodes 15 are formed by the following process: after the reflection electrodes 14 are formed on the interlayer insulating film 13, the portions of the reflection electrodes 14 in the transmission areas TA are removed by etching, and thereafter, the transparent electrodes 15 are formed by sputtering or the like.

In the example illustrated in FIG. 1, with a view to preventing the reflection electrodes 14 from peeling off and the like, the transparent electrodes 15 are provided on the reflection electrodes 14 as well, but the transparent electrodes 15 may be omitted on the reflection electrodes 14.

With this configuration in which the electrodes in the areas where the photospacers 17 are provided are the transparent electrodes 15, external light incident from the front side is not reflected in the areas where the photospacers 17 are provided. In a case where the display device is controlled to display black color during reflection display, therefore, the light leakage in the areas where the photospacers 17 are provided, and the occurrence of flicker during low frequency driving, can be prevented.

Further, since the areas where the photospacers 17 are provided do not contribute to reflection properties effectively from the first, even providing the transparent electrodes 15 in place of the reflection electrodes 14 does not substantially cause a large decrease in the reflection aperture ratio, which is indicative of the ratio of the area where the reflection electrodes 14 are formed, in the pixel area.

Still further, with the configuration in which the electrodes in the areas where the photospacers 17 are provided are the transparent electrodes 15, the areas that do not contribute to the reflection display effectively form the first are used as transmission display areas, which causes the transmission display areas to increase, thereby improving the display quality during transmission display.

On an interface between the photospacers 17 and the liquid crystal layer 16, the alignment of the liquid crystal molecules is disturbed, but in the present embodiment, the transparent electrodes 15 are provided in place of the reflection electrodes 14 not only in the areas where the photospacers 17 are provided, but also in margin areas having a margin width Ha, around the foregoing areas. This makes it possible to prevent the light leakage during black display, and the occurrence of flicker during low frequency driving, in areas of interface between the photospacers 17 and the liquid crystal layer 16.

Here, a liquid crystal display device of the following configuration can be suggested: a black matrix is formed in areas where the light leakage occurs during black color display, such as the areas where the photospacers are provided.

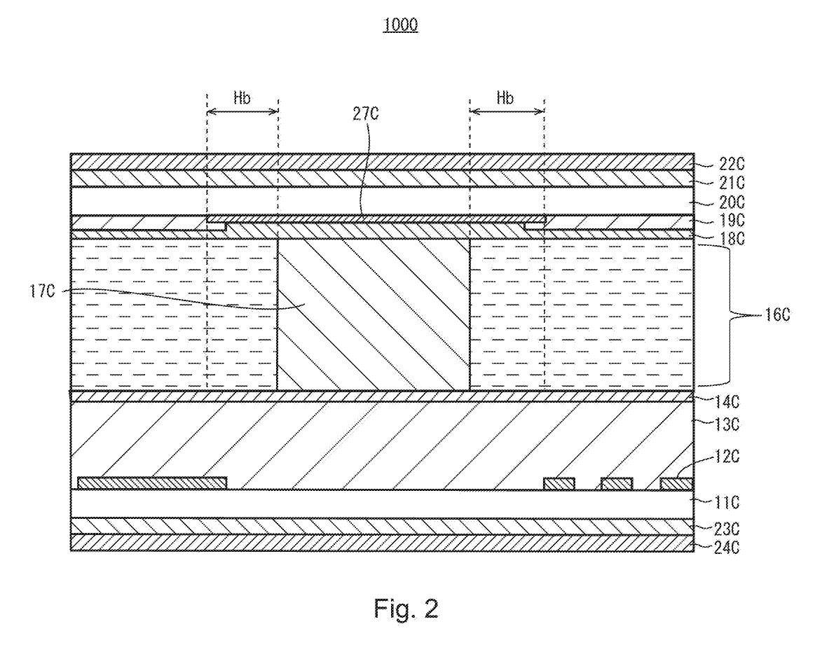

FIG. 2 is a cross-sectional view of a liquid crystal display device 1000 of a comparative example in which a black matrix 27c is formed in an area where photospacers 17c are provided. This liquid crystal display device 1000 is a reflection-type liquid crystal display device that performs reflection display by reflecting external light. In FIG. 2, the same constituent members as those in FIG. 1 are denoted by the same reference numerals to the end of which “c” is added.

As illustrated in FIG. 2, a black matrix 27c is formed in an area where the photospacer 17c is provided, and a margin area having a margin width Hb around the foregoing area, in the surface of the second substrate 20c on the liquid crystal layer 16c side. By forming the black matrix 27c, the light leakage in the area where the photospacer 17c is provided and the occurrence of flicker during low frequency driving can be prevented.

In a case where the black matrix 27c is formed, however, the reflection aperture ratio decreases for the black matrix 27c. In particular, in a case where the photospacers 17c are formed on the first substrate 11c side, the margin width Hb has to be set, with the following being taken into consideration: the accuracy in the forming of the black matrix 27c; the alignment margin for the alignment between the first substrate 11c on which the photospacers 17c are formed and the second substrate 20c on which the black matrix 27c is formed; and the like.

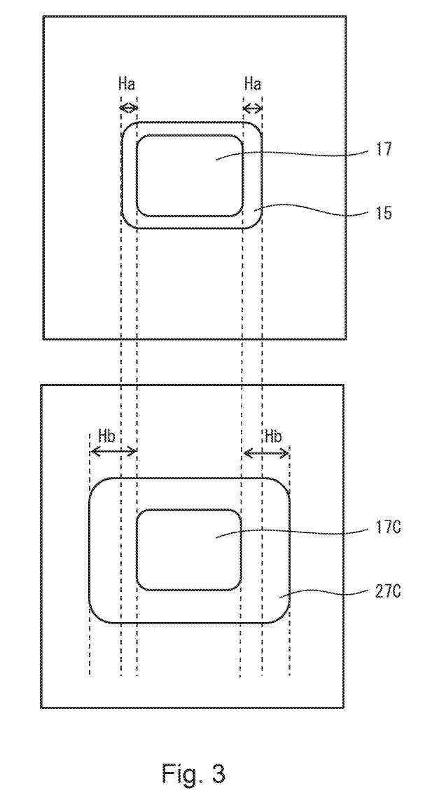

On the other hand, since the transparent electrodes 15 are formed on the side of the first substrate 11 on which the photospacers 17 are formed, it is not necessary to take the alignment margin for the alignment between the first substrate 11 and the second substrate 20 into consideration. As compared with the margin width Hb in the case where the black matrix 27c is formed, therefore, the margin width Ha in the case where the transparent electrodes 15 are formed is smaller. FIG. 3 is a plan view for comparing the margin width Ha in a case where the transparent electrodes 15 are formed, and the margin width Hb in a case where the black matrix 27c is formed. The upper diagram in FIG. 3 illustrates one pixel in the liquid crystal display device 100 in the present embodiment, and the lower diagram in FIG. 3 illustrates one pixel in the liquid crystal display device in the comparative example in which the black matrix 27c is formed.

Specifically, the liquid crystal display device 100 in the present embodiment in which transparent electrodes 15 are formed has a higher reflection aperture ratio, and thereby has a higher display quality, as compared with the liquid crystal display device 1000 in the comparative example in which the black matrix 27c is formed.

Incidentally, in a case where flicker occurs in the transmission areas TA during transmission display, the driving frequency may be increased (for example, 60 Hz).

### Embodiment 2

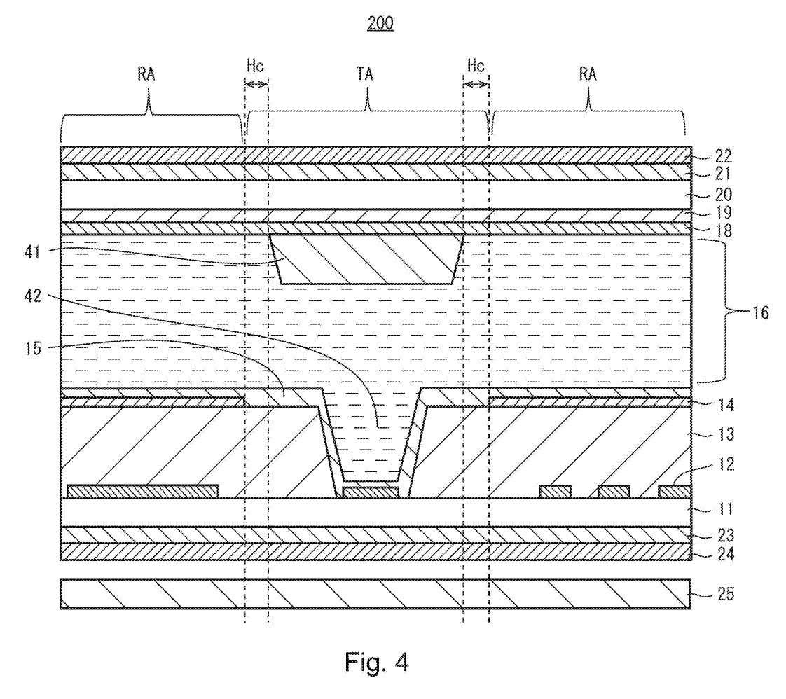

FIG. 4 is a cross-sectional view of a part of a liquid crystal display device 200 in Embodiment 2, the part being a part where an alignment regulation structural member 41 is provided. In FIG. 4, the same constituent members as those in FIG. 1 are denoted by the same reference numerals, respectively, and detailed descriptions of the same are omitted.

The liquid crystal display device 200 in Embodiment 2 is driven in the VA mode (vertical alignment mode). In the VA mode, when no voltage is applied, the liquid crystal molecules are aligned vertically to the first substrate 11 and the second substrate 20, and when a voltage is applied, the liquid crystal molecules are tilted.

In the vicinity of the center of each pixel, an alignment regulation structural member 41 for regulating the alignment of the liquid crystal molecules is provided.

The alignment regulation structural member 41 is also referred to as a rib. The alignment regulation structural member 41 is in a shape of protruding from the counter electrode 18 side downward (toward the first substrate 11 side), till the middle of the liquid crystal layer 16, and is made of, for example, an acrylic resin. The alignment regulation structural member 41, however, may have such a dimension as reaching the first substrate 11 side. The alignment regulation structural member 41 is thus provided, whereby the tilt alignment of the liquid crystal molecules is stabilized.

In the interlayer insulating film 13, a through hole 42 for electrically connecting the signal line 12 and the reflection electrode 14 is provided. The through hole 42 passes through the interlayer insulating film 13, and is in such a tapered shape that the diameter thereof gradually decreases from the side where the reflection electrode 14 is formed toward the side where the signal line 12 is formed. In the present embodiment, the through hole 42 is formed at such a position that, in plan view, the center of the through hole 42 coincides with the center of the alignment regulation structural member 41. Here, the alignment regulation structural member 41 is assumed to be larger than the through hole 42 in plan view.

In the conventional liquid crystal display device in which alignment regulation structural members are provided, the liquid crystal layer has different cell thicknesses in areas where the alignment regulation structural members are provided, and in areas where the same are not provided, respectively. When the display device is controlled to display black color, therefore, such a phenomenon occurs that light leaks and thereby contrast decreases, or that flicker occurs during low frequency driving, etc., in the areas where the alignment regulation structural members are provided.

Further, in the conventional liquid crystal display device, in areas where the through holes are formed, the liquid crystal layer has a greater cell thickness, and the alignment of the liquid crystal molecules is disturbed in the vicinity of the taper surfaces of the through holes. Therefore, in a case where the display device is controlled to display black color, such a phenomenon occurs that light leaks and thereby contrast decreases, or that flicker occurs during low frequency driving, etc., in the areas where the through holes are formed.

In the liquid crystal display device 200 in the present embodiment, in an area where the alignment regulation structural member 41 and the through hole 42 are provided, a transparent electrode 15 is provided in place of the reflection electrode 14. The transparent electrode 15 is an electrode that transmits light, formed with a material such as ITO or IZO. The transparent electrode 15 is in contact with the reflection electrode 14, and has the same potential. With this configuration, the signal lines 12 and the reflection electrode 14 are electrically connected via the transparent electrode 15 provided in the through hole 42.

In the present embodiment, the transparent electrode 15 is provided in place of the reflection electrode 14, not only in an area where the alignment regulation structural member 41 and the through hole 42 are provided, but also in a margin area having a margin width He around the foregoing area. The margin width He may be equal to the margin width Ha set in Embodiment 1. Here, since the configuration is such that the alignment regulation structural member 41 is larger than the through hole 42 in plan view, the transparent electrode 15 is provided in place of the reflection electrode 14 in the margin area having a margin width He around the alignment regulation structural member 41 as well. In a case where the through hole 42 is larger than the alignment regulation structural member 41, the transparent electrode 15 may be provided in place of the reflection electrode 14 in the margin area having a margin width He around the through hole 42 as well.

In this case, as illustrated in FIG. 4, the area where the reflection electrode 14 is provided is a reflection area RA at which external light incident from the front side is reflected, and the area where the transparent electrode 15 is provided in place of the reflection electrode 14 is a transmission area TA through which external light incident from the front side is transmitted. This transmission area TA is also an area that is used when image display is performed by using light of the backlight 25.

In the example illustrated in FIG. 4, the transparent electrode 15 is provided on the reflection electrodes 14 as well, with a view to preventing the transparent electrode 15 from peeling off and the like, but the transparent electrode 15 may be omitted on the reflection electrodes 14.

With this configuration in which the electrodes in the areas where the alignment regulation structural members 41 and the through holes 42 are provided are the transparent electrodes 15, external light incident from the front side is not reflected in the areas where the alignment regulation structural members 41 and the through holes 42 are provided. In a case where the display device is controlled to display black color, therefore, the light leakage in the areas where the alignment regulation structural members 41 and the through holes 42 are provided, and the occurrence of flicker during low frequency driving, can be prevented.

Further, since the areas where the alignment regulation structural members 41 and the through holes 42 are provided do not contribute to reflection properties effectively from the first, even providing the transparent electrodes 15 in place of the reflection electrodes 14 does not cause a large decrease in the substantial reflection aperture ratio.

Still further, with the configuration in which the electrodes in the areas where the alignment regulation structural members 41 and the through holes 42 are provided are the transparent electrodes 15, the areas that do not contribute to the reflection display effectively form the first can be made transmission display areas, which causes the transmission display areas to increase, thereby improving the display quality during transmission display.

On an interface between the alignment regulation structural members 41 and the liquid crystal layer 16, and on an interface between the through holes 42 and the liquid crystal layer 16, the alignment of the liquid crystal molecules is disturbed, but in the present embodiment, the transparent electrodes 15 are provided in place of the reflection electrodes 14 not only in the areas where the alignment regulation structural members 41 and the through holes 42 are provided, but also in the margin areas having a margin width Hc, around the foregoing areas. This makes it possible to prevent the light leakage during black display, and the occurrence of flicker during low frequency driving, in areas of an interface between the alignment regulation structural members 41 and the liquid crystal layer 16, and an interface between the through holes 42 and the liquid crystal layer 16.

Here, in a case where the alignment regulation structural members 41 and the through holes 42 are formed at different positions when viewed in plan view, it is necessary to provide the transparent electrodes 15 in place of the reflection electrodes 14 in the areas where the alignment regulation structural members 41 are provided and in the areas where the through holes 42 are provided. In this case, since the reflection areas where the reflection electrodes 14 are formed decrease, whereby the display quality during reflection display degrades. In the present embodiment, however, the alignment regulation structural members 41 and the through holes 42 are formed at the same positions, the reflection areas are larger, whereby the display quality during reflection display is higher, as compared with the case where they are formed at different positions.

Incidentally, a configuration in which each one pixel is divided into a plurality of areas and the alignment regulation structural member is provided in each area, for alignment regulation, is known. In such a configuration as well, the alignment regulation structural members and the through holes may be formed at the same positions when viewed in plan view, and transparent electrodes may be provided in place of the reflection electrodes, in areas where the alignment regulation structural members and the through holes are formed.

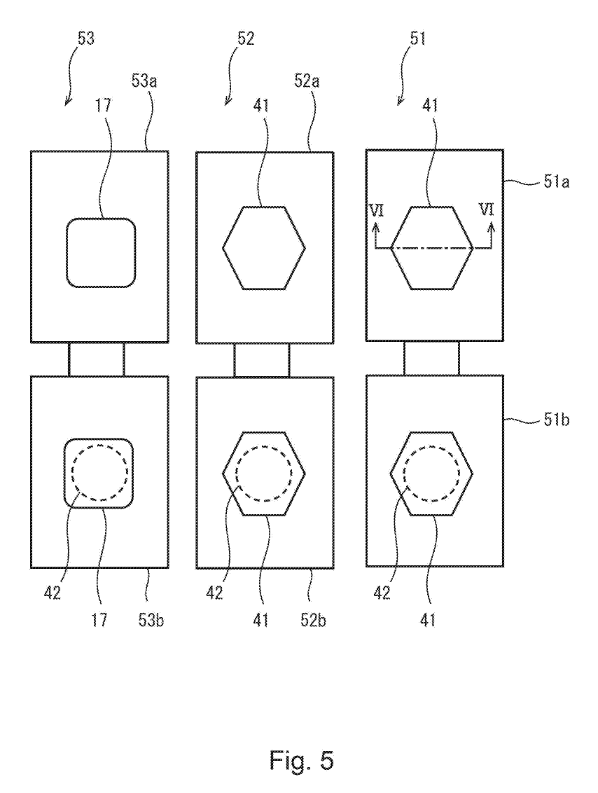

FIG. 5 is a plan view illustrating three pixels each of which is divided into two areas. In FIG. 5, in order to distinguish the photospacers 17, the alignment regulation structural members 41, and the through holes 42 from one another, they are illustrated in different shapes, respectively, but the respective shapes are not limited to the shapes illustrated in FIG. 5.

In the vicinity of the center of each of the areas 51a, 51b, which are obtained by dividing the pixel 51, the alignment regulation structural member 41 is provided. Further, in the area 51b, the through hole 42 is formed at such a position that the center position of the through hole 42 coincides with the center position of the alignment regulation structural member 41 when viewed in plan view.

Likewise, in the vicinity of the center of each of the areas 52a, 52b, which are obtained by dividing the pixel 52, the alignment regulation structural member 41 is provided. Further, in the area 52b, the through hole 42 is formed at such a position that the center position of the through hole 42 coincides with the center position of the alignment regulation structural member 41 when viewed in plan view.

In this case, in the area 51b of the pixel 51, and in the area 52b of the pixel 52, in the areas where the alignment regulation structural members 41 and the through holes 42 are formed, the transparent electrodes 15 are formed in place of the reflection electrodes 14, as described above.

In the example illustrated in FIG. 5, in each of areas 53a, 53b obtained by dividing the pixel 53, the photospacer 17 is provided. This photospacer 17 has a function of keeping the cell thickness, and a function of regulating the alignment of the liquid crystal molecules. In other words, in each of the areas 53a, 53b obtained by dividing the pixel 53, the photospacer 17 is provided in place of the alignment regulation structural member 41, so as to regulate the alignment of the liquid crystal molecules.

In the area 53b of the pixel 53, the through hole 42 is formed at such a position that the center position of the through hole 42 coincides with the center position of the photospacer 17 when viewed in plan view.

In this case, in the area 53b of the pixel 53, in the area where the photospacer 17 and the through hole 42 are formed, the transparent electrode 15 is formed in place of the reflection electrode 14. Further, in the area 53a of the pixel 53, in the area where photospacer 17 is formed, the transparent electrode 15 is formed in place of the reflection electrode 14, as is the case with Embodiment 1.

In the area 51a of the pixel 51, and in the area 52a of the pixel 52, no through hole 42 is provided, but the alignment regulation structural members 41 are provided.

In this case, in the area where the alignment regulation structural member 41 is provided, the transparent electrode 15 may be formed in place of the reflection electrode 14.

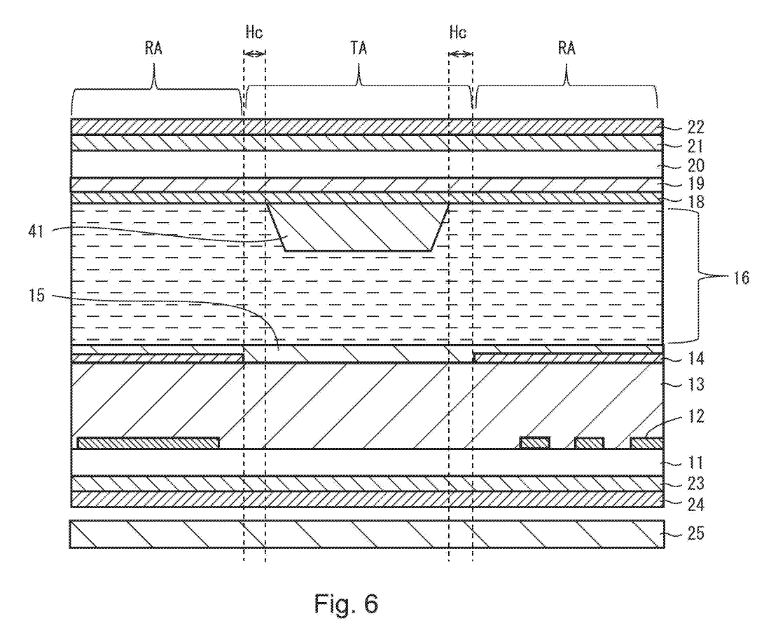

FIG. 6 is a cross-sectional view taken along line VI-VI in FIG. 5. As illustrated in FIG. 6, in the area extending over the alignment regulation structural member 41 and a margin area having a margin width Hc around the alignment regulation structural member 41, the transparent electrode 15 is provided in place of the reflection electrode 14. With this configuration, external light incident from the front side is not reflected in the area where the alignment regulation structural member 41 is provided. In a case where the display device is controlled to display black color, therefore, the light leakage in the areas where the alignment regulation structural members 41 are provided, and the occurrence of flicker during low frequency driving, can be prevented.

In the example illustrated in FIG. 6 as well, the transparent electrodes 15 are provided also on the reflection electrodes 14, with a view to preventing the transparent electrodes 15 from peeling off and the like, but the transparent electrodes 15 may be omitted on the reflection electrodes 14.

Besides, FIG. 6 illustrates an exemplary configuration in which the alignment regulation structural members 41 are provided on the second substrate 20 side, but they may be provided on the first substrate 11 side.

### Embodiment 3

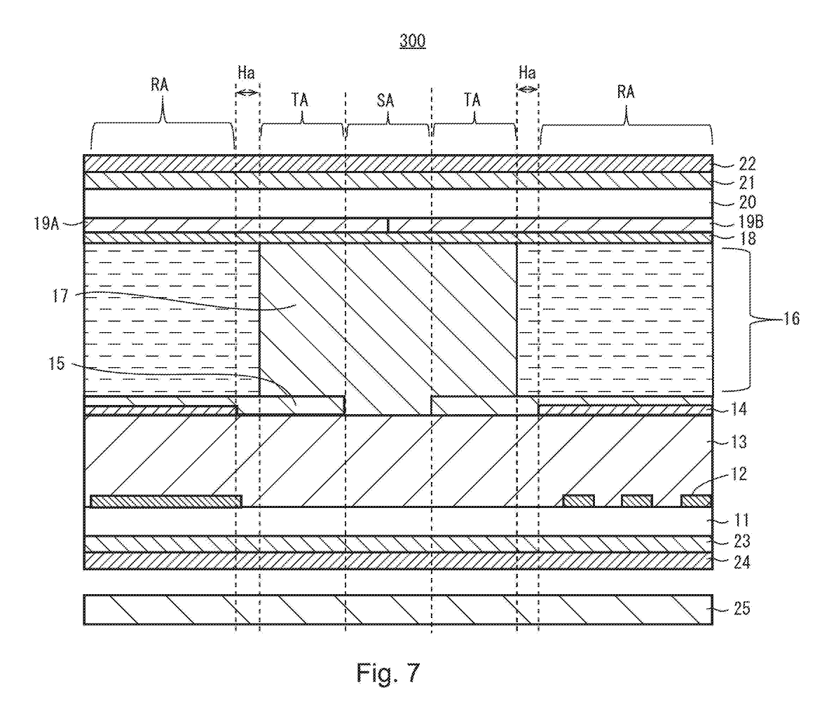

FIG. 7 is a cross-sectional view illustrating a part of a liquid crystal display device 300 in Embodiment 3, the part being a part where a photospacer 17 is provided. In FIG. 7, the same constituent members as those in FIG. 1 or FIG. 4 are denoted by the same reference numerals, respectively, and detailed descriptions of the same are omitted.

The photospacer 17 is provided so as to extend over two adjacent pixels. In FIG. 7, the area SA is an area between the two adjacent pixels.

In the present embodiment as well, as is the case with Embodiment 1, in an area where the photospacer 17c is provided, and a margin area having a margin width Ha around the foregoing area, the transparent electrode 15 is provided in place of the reflection electrode 14. In the area where the photospacer 17 is provided, however, neither the transparent electrode 15 nor the reflection electrode 14 is provided in the area between the two adjacent pixels. In other words, in the pixel area, in the area where the photospacer 17c is provided, and the margin area having the margin width Ha around the foregoing area, the transparent electrode 15 is provided in place of the reflection electrode 14.

In this case, as illustrated in FIG. 7, the area where the reflection electrode 14 is provided is a reflection area RA at which external light incident from the front side is reflected. Besides, the area where the transparent electrode 15 is provided in place of the reflection electrode 14 is a transmission area TA through which external light incident from the front side is transmitted. This transmission area TA is also an area that is used for performing image display by using light of the backlight 25.

Incidentally, in FIG. 7, the color filter 19A and the color filter 19B have different colors; for example, the color filter 19A is red (R), and the color filter 19B is blue (B).

Such a configuration is preferable for a liquid crystal display device of a diving mode such as the ECB mode, or the TN mode, in which an alignment regulation structural member is not necessary at the center of the pixel.

In such a configuration in which the photospacer 17 is provided in each area extending over two adjacent pixels, areas that do not contribute to display during reflection display can be reduced, as compared with the configuration in which the photospacer 17 is provided in a pixel. Further, in the pixel area, in the area where the photospacer 17 is provided, the transparent electrode 15 is provided in place of the reflection electrode 14. In a case where the display device is controlled to display black color, therefore, the light leakage in the areas where the photospacers 17 are provided, and the occurrence of flicker during low frequency driving, can be prevented.

Further, since the areas where the photospacers 17 are provided do not contribute to reflection properties effectively from the first, even providing the transparent electrodes 15 in place of the reflection electrodes 14 does not cause a large decrease in the substantial reflection aperture ratio.

Still further, with the configuration in which the electrodes in the areas where the photospacers 17 are provided are the transparent electrodes 15, the areas that do not contribute to the reflection display effectively form the first can be made transmission display areas, which causes the transmission display areas to increase, thereby improving the display quality during transmission display.

On an interface between the photospacers 17 and the liquid crystal layer 16, the alignment of the liquid crystal molecules is disturbed, but in the present embodiment, the transparent electrodes 15 are provided in place of the reflection electrodes 14 not only in the areas where photospacers 17 are provided, but also in margin areas having a margin width Ha, around the foregoing areas. This makes it possible to prevent the light leakage during black display, and the occurrence of flicker during low frequency driving, in areas of the interface between the photospacers 17 and the liquid crystal layer 16.

The photospacers 17 may be arranged at positions in any areas as long as each area extends over adjacent pixels.

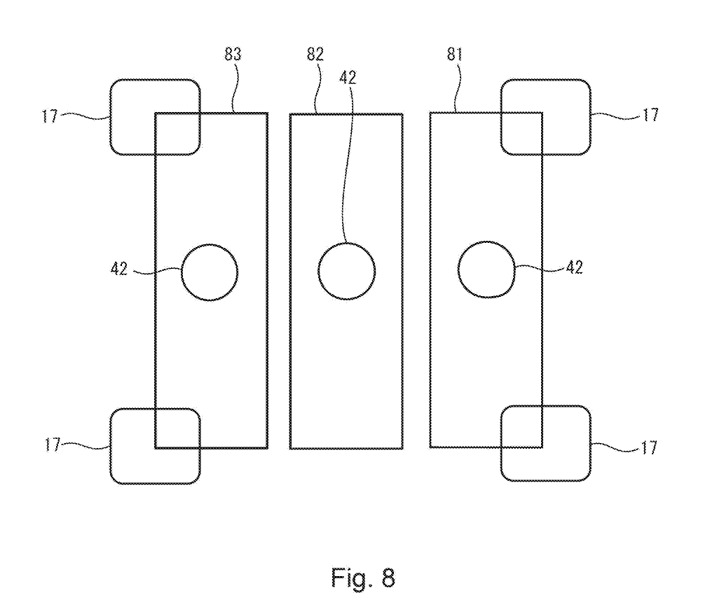

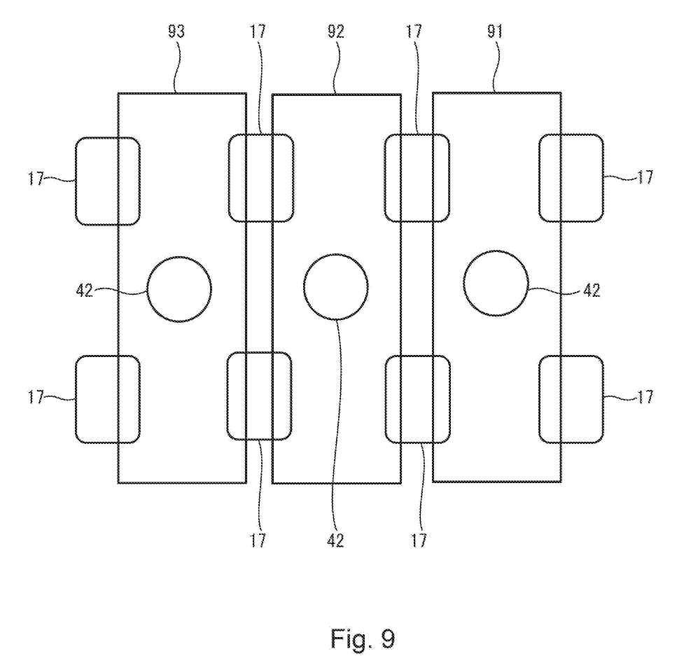

FIGS. 8 to 10 illustrate various positions at which the photospacers 17 are arranged. FIG. 8 illustrates an exemplary arrangement in which the photospacers 17 are provided at four corners of one display pixel composed of three adjacent pixels 81 to 83. FIG. 9 illustrates an exemplary arrangement in which the photospacers 17 are provided in such a manner that two photospacers 17 extend over two adjacent pixels.

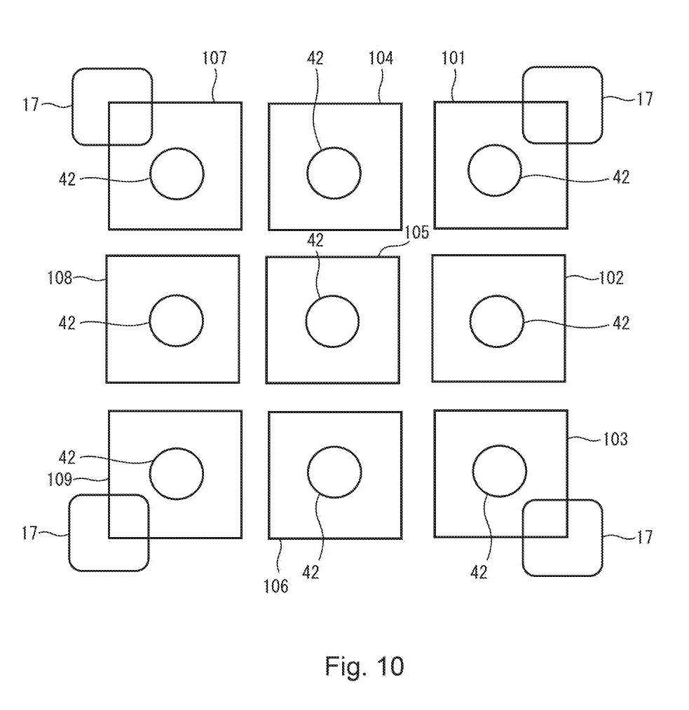

FIG. 10 illustrates an exemplary arrangement in which nine pixels 101 to 109 are assumed to be one unit, and the photospacers 17 are provided at four corners of this one unit.

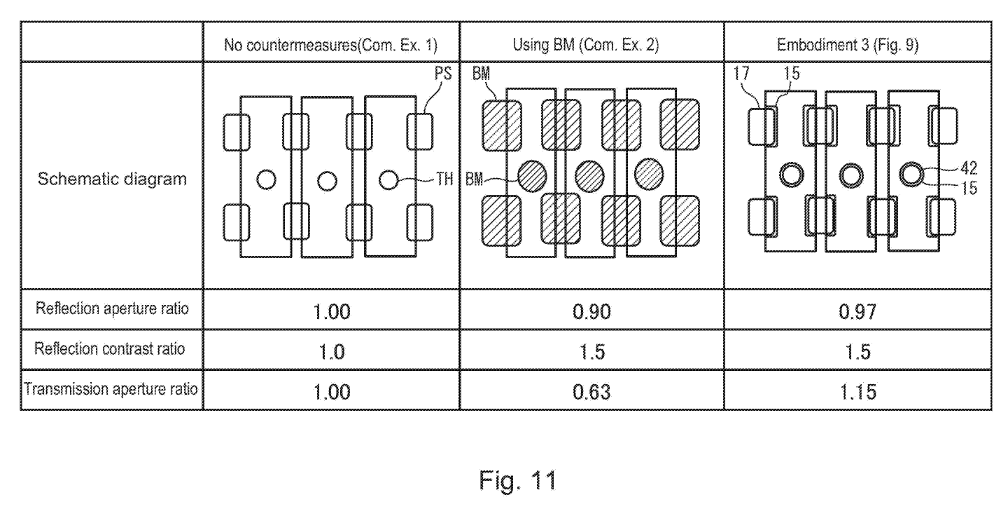

FIG. 11 is a diagram for comparing the reflection aperture ratios, the reflection contrast ratios, the and transmission aperture ratios of the following three configurations where photospacers are provided in areas that extend over adjacent pixels: “Without countermeasures (Comparative Example 1)”; “Using BM (Comparative Example 2)”; and “Embodiment 3 (FIG. 9)”.

The configuration of “Without countermeasures (Comparative Example 1)” is a configuration of a liquid crystal display device of Comparative Example 1 in which no countermeasure is made against the light leakage. “PS” in the schematic diagram denotes a photospacer, and “TH” denotes a through hole. In areas where the photospacers PS are provided, in the pixel area, reflection electrodes are provided.

The configuration of “Using BM (Comparative Example 2)” is a configuration of a liquid crystal display device of Comparative Example 2 in which areas where photospacers are provided and areas where through holes are provided are covered by a black matrix. “BM” in the schematic diagram denotes the black matrix.

The configuration of “Embodiment 3 (FIG. 9)” is a configuration of the liquid crystal display device 300 in Embodiment 3, in particular, a configuration in which the photospacers 17 are arranged, as in the exemplary arrangement illustrated in FIG. 9.

Regarding the “reflection aperture ratio”, the “reflection contrast ratio”, and the “transmission aperture ratio”, those of the configuration of “Using BM (Comparative Example 2)”, and those of the configuration of “Embodiment 3 (FIG. 9)” are indicated, which are with respect to those of the configuration of “Without countermeasures (Comparative Example 1)” as reference ratios (1.0). The reflection aperture ratio represents a ratio of an area where the reflection electrodes are formed with respect to the pixel area, and the reflection contrast ratio represents a contrast during reflection display. Further, the transmission aperture ratio represents a ratio of an area through which light is transmitted, with respect to the pixel area.

The configuration of “Using BM (Comparative Example 2)” has a reflection contrast of 1.5 times the reflection contrast of the configuration of “Without countermeasures (Comparative Example 1)”, but since the areas where the reflection electrodes are provided are partially covered by the black matrix, the reflection aperture ratio of the former is 0.9 time that of the latter. Moreover, since light is not transmitted in the areas where the black matrix is formed, the transmission aperture ratio of the former is 0.63 time that of the latter.

On the other hand, in the configuration of Embodiment 3, the reflection aperture ratio decreases for the areas where the transparent electrodes 15 are provided in place of the reflection electrodes 14, thereby being 0.97 time that of the latter, but the reflection contrast thereof is 1.5 times the latter. Besides, the configuration of Embodiment 3 has a transmission aperture ratio of 1.15 time that of the latter, since the transmission areas increase for the areas where the transparent electrodes 15 are provided in place of the reflection electrodes 14.

In other words, with the configuration of the present embodiment, the reflection contrast can be increased without a substantial decrease in the reflection aperture ratio, as compared with the configuration of the liquid crystal display device of Comparative Example 2 in which the black matrix is used. Further, in the case where the black matrix is used, the transmission aperture ratio decreases, but with the configuration of the present embodiment, the transmission aperture ratio increases, which makes it possible to improve the performance of image display using light of the backlight.

The present invention is not limited to the above-described embodiments. For example, the structural members provided in the liquid crystal layer 16 are not limited to the above-described photospacers 17 and alignment regulation structural members 41; they may be, for example, spacers for keeping the pressing force of the liquid crystal layer 16 (hereinafter referred to as sub-spacers). These sub-spacers have an effect of buffering the load pressing applied from the outside. They are provided on, for example, the second substrate 20, and each of the same has a shape that protrudes half way in the liquid crystal layer 16 (the protrusion has a length shorter than the thickness of the liquid crystal layer 16).

The present invention is not limited, either, by the shapes of the photospacers 17, the sub-spacers, and the alignment regulation structural members 41.

More specifically, if the configuration is such that no reflection electrode 15 is provided in areas where the structural members protruding from one of the first substrate 11 and the second substrate 20 toward the other substrate are provided, in the liquid crystal layer 16, it is possible to suppress, during black color display, the light leakage in the areas where the structural members are provided, and the occurrence of flicker during low frequency driving.

The liquid crystal display device 100 in Embodiment 1 is described above as a transflective liquid crystal display device, but it may be a reflection-type liquid crystal display device that does not include the backlight 25. In this case, the configuration may be such that in areas where the photospacers 17c are provided, and margin areas having a margin width Ha around the foregoing areas, transparent films having no conductivity may be provided in place of the transparent electrodes 15; or alternatively, the configuration may be such that the transparent electrodes 15 or the transparent films are not provided.

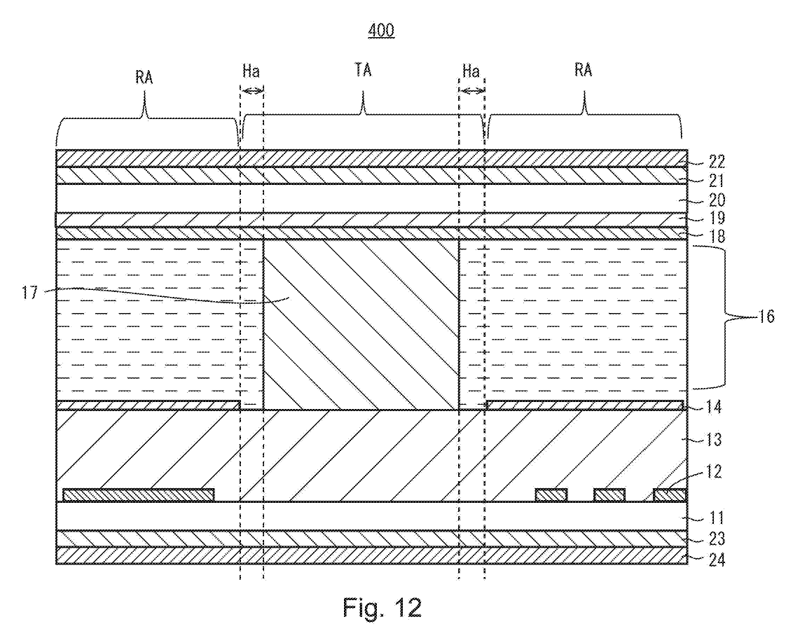

FIG. 12 is a cross-sectional view of a part of a liquid crystal display device 400 having such a configuration that no transparent electrode nor a transparent film is provided, the part being a part where a photospacer 17 is provided. This liquid crystal display device 400 is a reflection-type liquid crystal display device that does not include a backlight. The photospacers 17 are provided in the pixels.

As illustrated in FIG. 12, in the area where the photospacer 17 is provided, and a margin area having a margin width Ha around the foregoing area, no reflection electrode 14 is provided. With this configuration, external light incident from the front side is not reflected in the areas where the photospacers 17 are provided. In a case where the display device is controlled to display black color, therefore, the light leakage in the areas where the photospacers 17 are provided, and the occurrence of flicker during low frequency driving, can be prevented. Further, since the areas where the photospacers 17 are provided do not contribute to reflection properties effectively from the first, the substantial reflection aperture ratio does not largely decrease, even if no reflection electrode 14 is provided.

Likewise, the liquid crystal display device 200 in Embodiment 2 or the liquid crystal display device 300 in Embodiment 3 may be a reflection-type liquid crystal display device that does not include a backlight. In this case also, the configuration may be such that transparent films having no conductivity may be provided in place of the transparent electrodes 15; or alternatively, the configuration may be such that the transparent electrodes 15 or the transparent films are not provided.

In other words, the technique of the present disclosure can be applied to a liquid crystal display device capable of performing reflection display by reflecting external light, such as a reflection-type liquid crystal display device, or a transflective liquid crystal display device that has both of the characteristics of the transmission type and the reflection type. Examples of such a liquid crystal display device also include devices that have display sections in which liquid crystal is used, for example, electronic equipment such as portable information terminals and digital cameras.

### DESCRIPTION OF REFERENCE NUMERALS

11: first substrate
12: signal line
13: interlayer insulating film
14: reflection electrode
15: transparent electrode
16: liquid crystal layer
17: photospacer
18: counter electrode
19: color filter
20: second substrate
25: backlight
41: alignment regulation structural member
42: through hole
100, 200, 300, 400: liquid crystal display device

1. A liquid crystal display device capable of performing reflection display by reflecting external light, the liquid crystal display device comprising:
a first substrate;
a reflection electrode provided on the first substrate, for each pixel;
a second substrate provided so as to be opposed to the first substrate;
a liquid crystal layer provided between the first substrate and the second substrate; and
a structural member provided in the liquid crystal layer in such a manner that the structural member protrudes from one of the first substrate and the second substrate toward the other substrate,
wherein, in an area of each pixel, no reflection electrode is provided in an area where the structural member is provided.

2. The liquid crystal display device according to claim 1, further comprising:
a light source provided on a side opposite to a side on which the second substrate is provided, with respect to the first substrate; and
a transparent electrode provided in an area where the structural member is provided, in the area of each pixel.

3. The liquid crystal display device according to claim 1,
wherein the structural member includes at least one of a spacer having a length approximately equal to a thickness of the liquid crystal layer, a spacer having a length smaller than the thickness of the liquid crystal layer, and an alignment regulation structural member for regulating alignment of liquid crystal molecules of the liquid crystal layer.

4. The liquid crystal display device according to claim 3, further comprising:
an interlayer insulating film that has a through hole and is provided between the first substrate and the liquid crystal layer,
wherein the structural member includes the alignment regulation structural member, and the through hole is formed at a position at which the alignment regulation structural member is provided.

5. The liquid crystal display device according to claim 3,
wherein the structural member includes at least one of the spacer having a length approximately equal to the thickness of the liquid crystal layer, and the spacer having a length smaller than the thickness of the liquid crystal layer, and
the at least one of the spacer having a length approximately equal to the thickness of the liquid crystal layer and the spacer having a length smaller than the thickness of the liquid crystal layer is provided within the area of the pixel.

6. The liquid crystal display device according to claim 3,
wherein the structural member includes at least one of the spacer having a length approximately equal to the thickness of the liquid crystal layer, and the spacer having a length smaller than the thickness of the liquid crystal layer, and
the at least one of the spacer having a length approximately equal to the thickness of the liquid crystal layer and the spacer having a length smaller than the thickness of the liquid crystal layer is provided so as to extend over adjacent pixels.

7. The liquid crystal display device according to claim 1,
wherein no reflection electrode is provided, not only in the area where the structural member is provided, but also in a margin area having a predetermined width around the area where the structural member is provided.
